(19) United States
(12) Patent Application Publication
(10) Pub. No.: US 2018/0156700 A1
(43) Pub. Date: Jun. 7, 2018

(54) AUTOMATED SAMPLE STAINER AND A METHOD THEREOF

(71) Applicant: Adarsh NATARAJAN, Bangalore, Karnataka (IN)

(72) Inventors: Adarsh NATARAJAN, Bangalore (IN); Siddharth NAIR, Palakkad (IN)

(21) Appl. No.: 15/576,402

(22) PCT Filed: May 25, 2016
(86) PCT No.: PCT/IB2016/053055

§ 371 Date: Nov. 22, 2017

(30) Foreign Application Priority Data
May 25, 2015 (IN) 2599/CHE/2015

(51) Int. Cl. G01N 1/31; G01N 1/30; G01N 35/00; G01N 35/10; G06T 7/00; G06K 9/00

(52) U.S. Cl. CPC G01N 1/312; G06T 7/11; G01N 35/00722; G01N 35/00029; G01N 35/1083; G06T 7/0012; G06K 9/0014; G06K 9/00147; G01N 2035/0091; G01N 2035/00306; G01N 2035/00138; G01N 2035/1088; G06T 2200/24; G06T 2207/30024; G01N 1/30

(57) ABSTRACT

Embodiments of the present disclosure relates to a sample stainer for automatically staining samples with one or more reagents. The stainer comprises a trough base with predetermined pattern to hold one or more trough. Each trough comprises a plurality of compartments that is capable of being filled with one or more reagents required for staining samples. The stainer also comprises a slide holder for holding slides having sample collected from the users. The slide holder comprises a plurality of compartments, each compartment comprising one or more slots to hold the slides. The stainer further comprises a motion control unit that is configured to control the rotary motion of the trough base and linear motion of the slide holder during the staining process. The stainer also comprises a user interface configured to receive inputs including slide information and staining process related information from user to perform the staining of the sample.

### TECHNICAL FIELD

The present subject matter is related, to medical screening in general and more particularly, but not exclusively to a method and a system for screening for cervical cancer at point-of-sample collection.

### BACKGROUND

Cervical Cancer is the most deadly cancer for women in the World. Cervical cancer screening is commonly based on cytological and colposcopy analyses. The generally accepted gold standard in screening for cervical Cancer is the Pap smear Test (Papanicolaou test or Pap test). The common Pap smear detects cellular abnormalities and thus the development of potentially pre-cancerous lesions. In a Pap smear, the collected cervical cells are placed on a glass slide, stained and examined by a specially-trained and qualified cytotechnologist using a light microscope. Even though this test has led to a reduction in the incidences of and mortalities caused by cervical cancer, it is a subjective analysis with several known disadvantages, such as an increase in false-negatives and equivocal results as a consequence of debris obscuring abnormal cells. There may be a delay in analyzing and providing interpretation of the samples in geographical areas where there is poor infrastructure. This delay not only discourages women from testing but also makes follow up very difficult.

Hence, there exists a need for a method and a system for screening cervical cancer that has improved effectiveness of the screening at the point-of-sample collection and reduces the delay in delivering the screening results.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Embodiments of the present disclosure relates to a method of screening for cervical cancer. The method comprising the steps of receiving a sample on one or more slides used for collecting the sample and staining the received sample using one or more reagents. The method further comprises the step of capturing one or more set of images of the stained sample positioned at one or more positions and illuminated at a plurality of angular degrees. Upon capturing the one or more set of images of the stained sample, the method performs segmentation into one or more cell regions and further classifying the one or more determined cell regions into one or more cell types based on one or more features extracted from the cell regions. Further, the method comprises the step of determining a confidence score and determining one or more stages of cancer of the one or more cell regions based on the confidence score and one or more cell types thus determined.

In another aspect, the present disclosure relates to a system for screening cervical cancer of a user. The system comprises one or more slides for collecting sample from user and a sample stainer coupled with the slides. The sample stainer is configured to automatically stain the received sample with one or more reagents to obtain a stained sample. The medical screening system further comprises an image acquisition unit configured to capture one or more set of images of the stained sample illuminated at a plurality of angular degrees by positioning the one or more slides at one or more positions. Further, the system comprises a data repository for storing the one or more set of images thus captured. The system also comprises an image processing unit comprising a processor; and a memory communicatively coupled to the processor. The processor is configured to segment the one or more set of images into one or more cell regions and classify the one or more cell regions into one or more cell types based on one or more features extracted from the one or more cell regions. Further, the processor is configured to determine a confidence score indicating probability of the one or more cell regions likely to be cervical cancerous regions and further determine one or more stages of cancer of the one or more cell regions based on the one or more cell type and the confidence score thus determined.

Further, the present disclosure relates to a sample stainer for automatically staining samples with one or more reagents to obtain the stained sample. The stainer comprises a trough base configured with a predetermined pattern to hold one or more trough. Each trough comprises a plurality of compartments and each compartment is capable of being filled with the one or more reagents required for staining samples. The stainer also comprises a slide holder for holding slides having sample collected from the users. The slide holder comprises a plurality of compartments, each compartment comprising one or more slots to hold the slides. The stainer further comprises a motion control unit coupled with the trough base and the slide holder. The motion control unit is configured to control the rotary motion of the trough base and linear motion of the slide holder during the staining process. The stainer also comprises a user interface coupled with the motion control unit, configured to receive inputs including slide information and staining process related information from user to perform the staining of the sample. Furthermore, the stainer comprises a processor coupled with the user interface and a memory communicatively coupled to the processor. The processor is configured to receive one or more command signals associated with the user inputs from the user interface and actuate the motion control unit to control the rotary motion of the trough base and the linear motion of the slide holder in accordance with the one or more command signals thus received to perform the staining process. Upon completion of the staining process, the processor generates a notification signal indicative of completion of the staining process to the user.

Furthermore, the present invention relates to a method of staining a sample. The method comprising the steps of receiving one or more command signals associated with user inputs from a user interface and actuating a motion control unit to control rotary motion of a trough base and linear motion of a slide holder in accordance with the one or more command signals thus received. Further, the method comprises the step of generating a notification signal indicating completion of the staining process to the user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristics of the disclosure are explained herein. The embodiments of the disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawing in which:

FIG. 1 illustrates exemplary architecture of a system for screening for cervical cancer in accordance with some embodiments of the present disclosure;

FIGS. 2a, 2b, and 2c illustrate exemplary front view, isometric view and top views respectively of an automated sample stainer in accordance with one embodiment of the present disclosure;

FIG. 3a illustrates an exemplary top view of a trough base of FIG. 2a in accordance with some embodiments of the present disclosure; FIGS. 3b and 3c illustrate exemplary isometric view and top view of a trough of FIG. 2a in accordance with some embodiments of the present disclosure; FIGS. 3d and 3e illustrate exemplary isometric and top views of a slide holder of FIG. 2a in accordance with some embodiments of the present disclosure; and

FIGS. 4a, 4b, and 4c illustrate exemplary front view, isometric view and top views respectively of an automated sample stainer in accordance with another embodiment of the present disclosure; and

FIG. 5 illustrates a flowchart of a method of screening for cervical cancer in accordance with some embodiments of the present disclosure;

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter. It should be appreciated by those skilled in the art that the conception and specific embodiment disclosed may be readily utilized as a basis for modifying or designing other structures for carrying out the same purposes of the present disclosure. The novel features which are believed to be characteristic of the disclosure, both as to its organization and method of operation, together with further objectives and advantages will be better understood from the following description when considered in connection with the accompanying figures. It is to be expressly understood, however, that each of the figures is provided for the purpose of illustration and description only and is not intended as a definition of the limits of the present disclosure.

The present disclosure relates to a method and system for screening cervical cancer at point-of-sample collection. In one embodiment, a sample collected from a user is deposited on a slide and stained with suitable reagents. The stained sample on the slide is then disposed on the system for capturing one or more images of the stained sample. The captured images are then processed to classify the processed images into one or more images of normal and abnormal samples. Based on the classification, one or more reports are generated and forwarded to experts or cytotechnologist or cyto-pathologists for further analysis. Thus, the present disclosure enables the interpretation and screening of the samples at the point-of-sample collection center and avoids the delay in forwarding the sample to the centralized place for experts analysis and interpretation report being sent back to the point of sample collection.

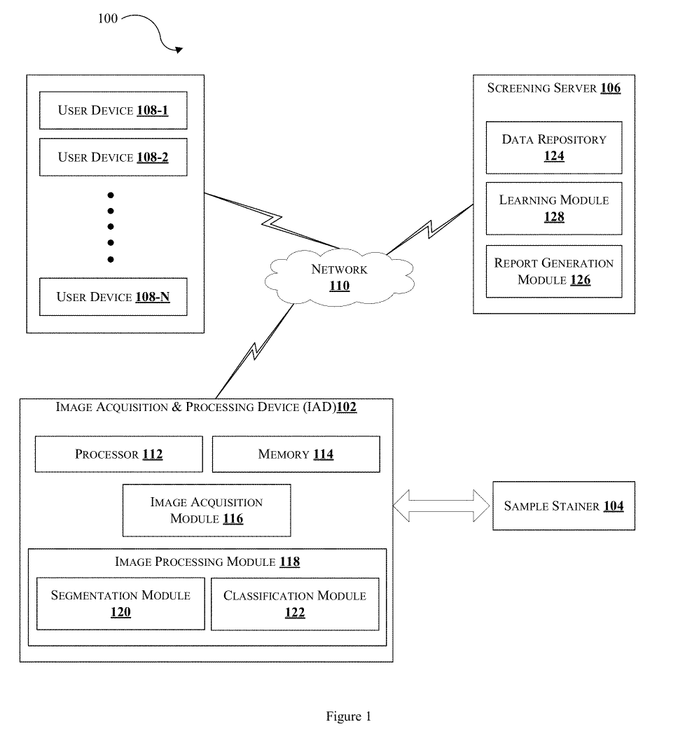

FIG. 1 illustrates block diagram of a system (100) for screening for cervical cancer in accordance with some embodiments of the present disclosure.

In one embodiment, the system (100) comprises at least one Image Acquisition & Processing Device (IAD) (102), a sample stainer (104), a screening server (106) and one or more user devices (108-1), (108-2), . . . (108-N) (collectively referred to as user device 108) of one or more users coupled via the network (110). The users may be experts like cytotechnologists or cyto-pathologists and the user devices (108) may be for example, a mobile device generally a portable computer or a computing device including the functionality for communicating over the network (110). For example, the mobile device can be a mobile phone, a tablet computer, a laptop computer, a handheld game console, or any other suitable portable devices. The network (110) may include, without limitation, a direct interconnection, local area network (LAN), wide area network (WAN), wireless network (e.g., using Wireless Application Protocol), the Internet, etc.

In one embodiment, a patient visits a health worker or a clinician who obtains a sample of for example, cervical cells using known standard methods. The health worker or the clinician then fixes the sample on a medium such as a slide using known laboratory techniques that enables slide preparation. The slide preparation is a process where the slide is uniformly processed and fixed followed by a process called as cover slipping. A slide is prepared using known fixation techniques of medium such as for example cyto fix, and then subjected to staining process. For example, the slide is prepared by depositing proportionate and representative cells from the sample onto the slide and the slide is then subjected to the staining process. The sample stainer (104) comprises a slide holder for holding the slide comprising the sample and is configured to stain the sample with one or more reagents to distinguish the cells from one another using staining techniques. The sample stainer (104) may be a portable sample stainer and may be directly coupled with the IAD (102). In another embodiment, the sample stainer (104) may be integrated within the IAD (102). The stained sample is then subjected to screening process by IAD (102) to evaluate potential abnormalities in the sample and identify cells or cell-clusters that require further review by experts like cytotechnologists or cyto-pathologists.

The IAD (102) may be a portable system and capable of communicating with the sample stainer (104) and the screening server (106) and the user devices (108) via the network (110). In one embodiment, the IAD (102) includes a central processing unit (“CPU” or “processor”) (112), a memory (114) and an I/O interface (not shown). The I/O interface is coupled with the processor (112) and an I/O device. The I/O device is configured to receive inputs via the I/O interface and transmit outputs for displaying in the I/O device via the I/O interface. The IAD (102) further includes one or more modules comprising at least an image acquisition module (116) and an image processing module (118) that comprises a segmentation module (120) and a classification module (122). The image acquisition module (116) is configured to acquire one or more set of images of the stained sample illuminated by an illumination source at a plurality of angular degrees positioning the stained sample at one or more positions. Upon capturing, the segmentation module (120) segments the one or more set of images of the stained sample into one or more cell regions for further classification. The classification module (122) classifies the one or more cell regions into one or more cell types based on one or more features extracted from the one or more cell regions. Upon classification, the image processing module (118) determines a confidence score indicating probability of the one or more cell regions likely to be cervical cancerous regions. Based on the one or more cell type and the confidence score, the image processing module (118) determines one or more stages of cancer of the one or more cell regions. The image processing module (118) further enables the report generation based on the determination of stages of cancerous cell from cell regions.

In one embodiment, the screening server (106) is configured to generate the report based on the determination of stages of cancerous cell by the image processing module (118). The screening server (106) comprises a data repository (124) configured to store the one or more set of images thus captured by the image acquisition module (116). The data repository (124) is also configured to store one or more training dataset comprising training images of one or more cell types and one or more stages of cancer, one or more data models and report generated. In one aspect, the screening server (106) comprises a report generation module (126) and a learning module (128). In another embodiment, the screening server (106) comprises the image processing module (118). The report generation module (126) is configured to generate one or more report comprising information associated with the one or more cell regions, the cell type and the confidence score, one or more recommendations of follow-up test procedures to be conducted and analysis opinion provided by a cytologist or by the image processing module in the server based on the cell type and the confidence score thus determined. The screening server (106) also enables transmission of the one or more reports generated to the user device (108) and also to point of care centers. In one example, the screening server (106) transmits one or more notifications to the user device (108) via email/API/web interface/SMS or other channels of information to users regarding scheduling next visit, reports, and system status/updates.

Upon report generation, the learning module (128) is configured to update one or more data models previously created and stored in the data repository (124) of the screening server (106). In one embodiment, the learning module (128) is configured to create the one or data models comprising the one or more set of images of the stained sample, one or more cell regions, the cell type and the confidence score associated with a particular sample collected from a particular user along with relevant parameters and features that are obtained and observed during the image processing. Further, the learning module (128) is configured to update the one or more data models and the machine learning models and relevant parameters associated with the sample obtained during the image processing with the cell type and the confidence score associated with a recently collected sample and any inputs received from the user device (108) including opinion or annotation regarding the confirmation of cell analysis.

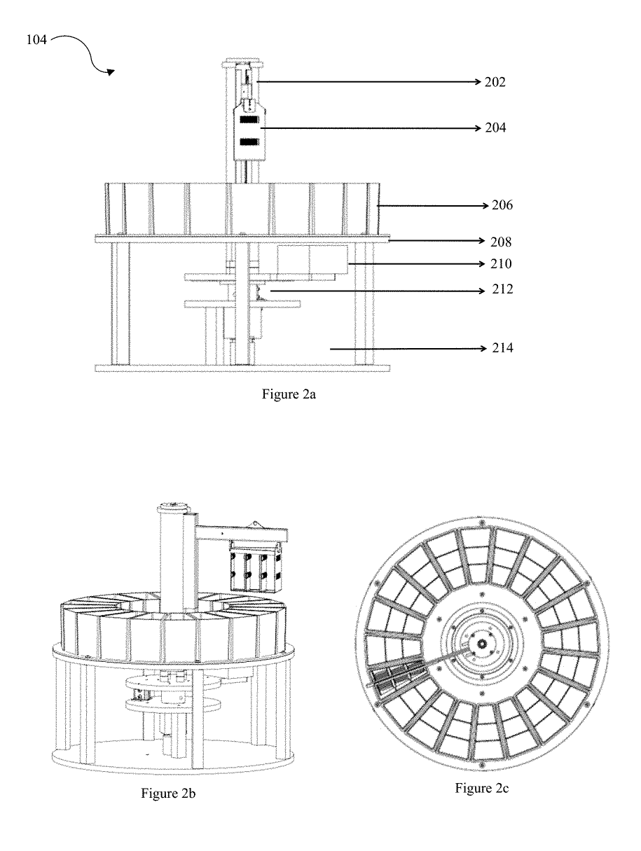

FIGS. 2a, 2b, and 2c illustrate exemplary front view, isometric view and top views respectively of an automated sample stainer in accordance with one embodiment of the present disclosure.

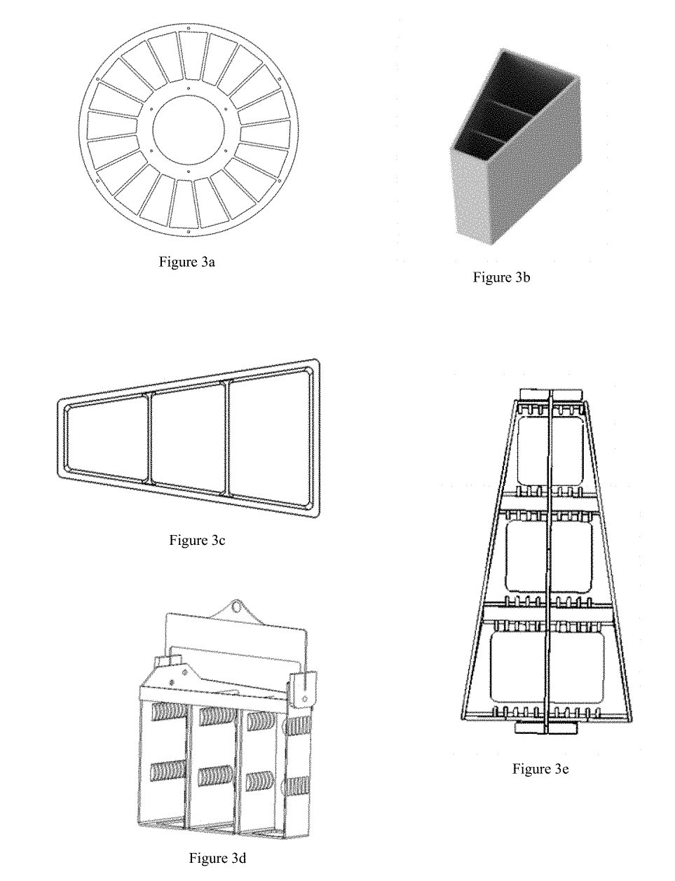

As illustrated, the automated sample stainer (104) comprises a linear motion control unit (202), a slide holder (204), a trough (206), a trough base & enclosure (208), an actuation control (210), a carousel control unit (212) and a user interface (214). The trough base (208), as illustrated in FIG. 3a, is configured with a predetermined pattern to hold the one or more trough (206). In one example, the trough base (208) comprises 20 troughs filled with the one or more reagents. The enclosure is configured for housing the sample stainer, and made of light weight material for enabling ease of carrying. The enclosure also helps in improving the thermodynamics of the system, easy handling and also prevents the components of the automated stainer (104) from having any kind of direct impact in any case of mishandling.

As illustrated in FIGS. 3b and 3c, each trough (206) comprises a plurality of compartments and each compartment is capable of being filled with one or more reagents required for staining one or more samples. The slide holder (204) is also configured with a plurality of compartments, each compartment comprising one or more slots to hold one or more slides having sample collected from users. FIGS. 3d and 3e illustrate an exemplary slide holder with three compartments for holding one or more slots for holding sample slides. In one example, each trough (206) comprises three compartments; each compartment is configured to carry 6, 8 and 10 or more slides respectively.

The linear motion control unit (202) and the carousel control unit (212) can be collectively referred to as motion control unit. The motion control unit is coupled with the trough base (208) and the slide holder (204), configured to control the rotary motion of the trough base (208) and linear motion of the slide holder (204). The user interface (214) is coupled with the motion control unit, configured to receive inputs including slide information and staining process related information from user to perform the staining of the sample. In one embodiment, the linear motion control unit (202) comprises at least an artificial arm configured to move in at least linear motion i.e. along the Z-axis and capable of carrying the slide holder (204) and dipping in the one or more trough (206) filled with one or more reagents for a predetermined time period and for predetermined number of dippings. The linear motion control unit (202) also comprises a linear motion actuation unit coupled with the artificial arm, configured to actuate at least the linear motion of the artificial arm. Further, the linear motion control unit (202) comprises a motion limit sensor coupled with the linear motion actuation unit, configured to limit the actuation of the linear motion actuation unit so as to control the movement of the artificial arm based on the user inputs. The motion limit sensor is configured to indicate the current position of the artificial arm attached in the linear motion actuation unit.

The carousel motion control unit (212) comprises at least a rotary turn table configured to rotate in at least radial motion and capable of carrying the one or more trough (206) filled with one or more reagents. Further, the carousel motion control unit (212) comprises a carousel motion actuation unit coupled with the rotary turn table, configured to actuate at least the radial motion of the rotary turn table. Furthermore, the carousel motion control unit (212) comprises one or more position sensors coupled with the carousel motion actuation unit, configured to provide at least information on actual movement of the carousel motion actuation unit and movement of the artificial arm attached to the linear actuation system by at least one trough (506). The one or more position sensor also indirectly provides information related to the current step in the staining process.

The actuation control (210) comprises of one or more motors and drivers to enable linear motion in the Z-axis. Further, the automated stainer (104) comprises a processor coupled with the user interface and a memory communicatively coupled to the processor. The processor is configured to receive one or more command signals associated with the user inputs from the user interface and actuate the motion control unit to control the rotary motion of the trough base and the linear motion of the slide holder in accordance with the one or more command signals thus received to perform the staining process. Upon completion of the staining process, the processor generates a notification signal indicative of completion of the staining process to the user.

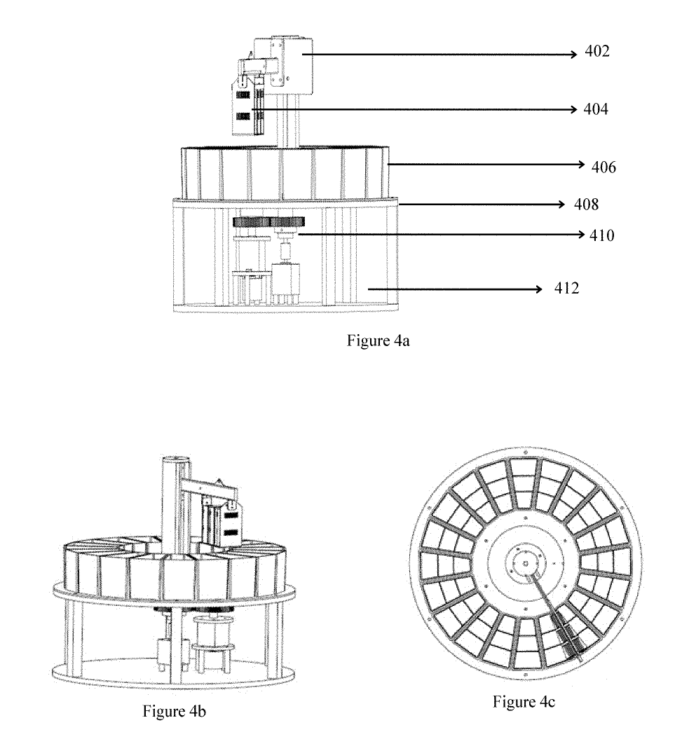

FIGS. 4a, 4b, and 4c illustrate exemplary front view, isometric view and top views respectively of the automated sample stainer (104) in accordance with another embodiment of the present disclosure. The automated sample stainer, as illustrated, comprises at least a linear motion control unit (402), a slide holder (404), a trough (406), a trough base & enclosure (408), a carousel control unit (410) and a user interface (412).

### Advantages of the Present Invention

The present invention relates to a portable, low weight, easy to carry slide stainer used for staining samples collected at point of care centers. Further, the stainer is compartmentalized into smaller compartments so as to accommodate multiple reagents and optimize the usage of trough in the staining process. The device can be operated by an unskilled resource with a minimum training to operate the slide stainer.

As described above, the modules, amongst other things, include routines, programs, objects, components, and data structures, which perform particular tasks or implement particular abstract data types. The modules may also be implemented as, signal processor(s), state machine(s), logic circuitries, and/or any other device or component that manipulate signals based on operational instructions. Further, the modules can be implemented by one or more hardware components, by computer-readable instructions executed by a processing unit, or by a combination thereof.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art.

We claim:

1. A sample stainer, comprising:
a trough base configured with a predetermined pattern to hold one or more trough, each trough comprising a plurality of compartments and each compartment is capable of being filled with one or more reagents required for staining one or more samples;
a slide holder comprising a plurality of compartments, each compartment comprising one or more slots to hold one or more slides having sample collected from users;
a motion control unit, coupled with the trough base and the slide holder, configured to control the rotary motion of the trough base and linear motion of the slide holder; and
a user interface coupled with the motion control unit, configured to receive inputs including slide information and staining process related information from user to perform the staining of the sample;
a processor coupled with the user interface; and
a memory communicatively coupled to the processor, wherein the memory stores processor-executable instructions, which, on execution, cause the processor to:
receive one or more command signals associated with the user inputs from the user interface;
actuate the motion control unit to control the rotary motion of the trough base and the linear motion of the slide holder in accordance with the one or more command signals thus received to perform the staining process; and
generate a notification signal indicative of completion of the staining process to the user.

2. The stainer as claimed in claim 1, wherein the motion control unit comprises a linear motion control unit, wherein the linear motion control unit comprises at least:
an artificial arm configured to move in at least linear motion and capable of carrying the slide holder and dipping in the one or more trough filled with one or more reagents;
a linear motion actuation unit coupled with the artificial arm, configured to actuate at least the linear motion of the artificial arm; and
a motion limit sensor coupled with the linear motion actuation unit, configured to limit the actuation of the linear motion actuation unit so as to control the movement of the artificial arm based on the user inputs.

3. The stainer as claimed in claim 1, wherein the motion control unit further comprises a carousel motion control unit coupled with the linear motion control unit, wherein the carousel motion control unit comprises at least:
a rotary turn table configured to rotate in at least radial motion and capable of carrying the one or more trough filled with one or more reagents;
a carousel motion actuation unit coupled with the rotary turn table, configured to actuate at least the radial motion of the rotary turn table; and
one or more position sensors coupled with the carousel motion actuation unit, configured to provide at least information on actual movement of the carousel motion actuation unit and movement of at least one trough.

4. The stainer as claimed in claim 1, wherein each trough comprises three compartments, each compartment is configured to carry 6, 8 and 10 slides respectively.

5. The stainer as claimed in claim 1, wherein the trough base comprises 20 troughs filled with the one or more reagents.

6. The stainer as claimed in claim 1, further comprising an enclosure for housing the sample stainer, and made of light weight material.

7. A method of staining a sample, comprising:
receiving one or more command signals associated with user inputs from a user interface;
actuating a motion control unit to control rotary motion of a trough base and linear motion of a slide holder in accordance with the one or more command signals thus received to perform the staining process; and
generating a notification signal indicative of completion of the staining process to the user.
